(19) United States
(12) Patent Application Publication
(10) Pub. No.: US 2017/0034538 A1
(43) Pub. Date: Feb. 2, 2017

(54) Encode/Decode Strategy for Mitigating Irregular Stream Decoding Time

(71) Applicant: Sony Computer Entertainment Inc., Tokyo (JP)

(72) Inventor: Hung-Ju Lee, Pleasanton, CA (US)

(21) Appl. No.: 14/810,013

(22) Filed: Jul. 27, 2015

(51) Int. Cl. H04N 19/91; H04N 19/172; H04N 19/463; H04N 19/50

(52) U.S. Cl. CPC H04N 19/91; H04N 19/50; H04N 19/172; H04N 19/463

(57) ABSTRACT

Aspects of the present disclosure include methods and systems for encoding and decoding digital pictures. Encoding may include determining a frame type of the digital picture, and encoding the digital picture with an entropy coding method in accordance with the frame type of the digital picture. Decoding may include determining whether an encoded digital picture includes decoding method identifying information that specifies an encoding method used to encode the encoded digital picture; and decoding the digital picture using an entropy coding method in accordance with the identifying information when the encoded digital picture includes the encoding method identifying information.

### FIELD OF THE DISCLOSURE

Aspects of the present disclosure are related to encoding and decoding of digital data. In particular, aspects of the present disclosure are related to strategies for reducing decoding time for a data stream.

### BACKGROUND

Digital signal compression (sometimes referred to as video coding or video encoding) is widely used in many multimedia applications and devices. Digital signal compression using a coder/decoder (codec) allows streaming media, such as audio or video signals to be transmitted over the Internet or stored on compact discs. A number of different standards of digital video compression have emerged, including H.261, H.263; DV; MPEG-1, MPEG-2, MPEG-4, VC1; AVC (H.264), and HEVC (H.265). These standards, as well as other video compression technologies, seek to efficiently represent a video frame picture by eliminating the spatial and temporal redundancies in the picture and among successive pictures. Through the use of such compression standards, video contents can be carried in highly compressed video bit streams, and thus efficiently stored in disks or transmitted over networks.

It is within this context that aspects of the present disclosure arise.

### BRIEF DESCRIPTION OF THE DRAWINGS

The teachings of the present disclosure can be readily understood by considering the following detailed description in conjunction with the accompanying drawings, in which:

FIG. 1 is a schematic diagram illustrating one possible division of a streaming data picture within the context of aspects of the present disclosure.

FIGS. 2A and 2B are graphs illustrating a general relationship between bitrate/decoding time and CABAC encoded frames in a streaming data picture within the context of aspects of the present disclosure.

FIGS. 3A and 3B are graphs illustrating a general relationship between bitrate/decode time and CABAC and CAVLC encoded frames in a streaming data picture within the context of aspects of the present disclosure.

FIG. 4 is a flow diagram illustrating digital picture encoding in accordance with aspects of the present disclosure.

FIG. 5 is a flow diagram illustrating digital picture decoding in accordance with aspects of the present disclosure.

FIG. 6 is a block diagram illustrating an example of a computer system configured to operate in accordance with aspects of the present disclosure.

### DESCRIPTION OF THE EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

### INTRODUCTION

Aspects of the present disclosure are directed to solutions to the problem of irregular decoding time during decoding of streaming data, especially for high bitrate video streaming and gaming streaming applications. Irregular decoding time occurs when decoding a non-predictive frame, e.g., an Intra Frame (I-frame). I-frames typically require more bits to encode than predictive frames (P-frames), and thus they need more time to decode in conventional codec (e.g., using Context Adaptive Binary Arithmetic Coding (CABAC)) compared to P-frames.

Before describing solutions to the problem of irregular decoding time during decoding of streaming data in accordance with aspects of the present disclosure, it is useful to understand how digital pictures, e.g., video pictures are encoded/decoded for streaming applications. In the context of aspects of the present disclosure, video data may be broken down in suitable sized units for coding and decoding. For example, in the case of video data, the video data may be broken down into pictures with each picture representing a particular image in a series of images. Each unit of video data may be broken down into sub-units of varying size. Generally, within each unit there is some smallest or fundamental sub-unit. In the case of video data, each video frame may be broken down into pixels, each of which contains luma (brightness) and chroma (color) data.

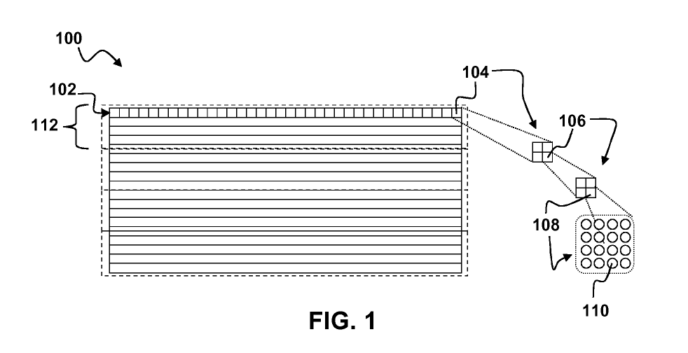

By way of example, and not by way of limitation, as shown in FIG. 1, a single picture 100 (e.g., a digital video frame) may be broken down into one or more sections. As used herein, the term “section” can refer to a group of one or more luma or chroma samples within the picture 100. A section can range from a single luma or chroma sample within the picture, up to the whole picture. Non-limiting examples of sections include slices (e.g., macroblock rows) 102, macroblocks 104, sub-macroblocks 106, blocks 108 and individual pixels 110. As illustrated in FIG. 1, each slice 102 contains one or more rows of macroblocks 104 or portions of one or more such rows. The number of macroblocks in a row depends on the size of the macroblocks and the size and resolution of the picture 100. For example, if each macroblock contains sixteen by sixteen chroma or luma samples then the number of macroblocks in each row may be determined by dividing the width of the picture 100 (in chroma or luma samples) by sixteen. Each macroblock 104 may be broken down into a number of sub-macroblocks 106. Each sub-macroblock 106 may be broken down into a number of blocks 108 and each block may contain a number of chroma or luma samples 110. By way of example, and without limitation of the invention, in a common video coding scheme, each macroblock 104 may be broken down into four sub-macroblocks 106. Each sub-macroblock may be broken down into four blocks 108 and each block may contain a four by four arrangement of sixteen chroma or luma samples 110. Some codecs, such as H.265, allow a given picture to be broken down into two or more sections of different sizes for encoding. In particular, the H.265 standard introduces the “tile” concept of partitioning a picture. Tiles are independently decodable regions of a picture that are encoded with some shared header information. Tiles can additionally be used for the purpose of spatial random access to local regions of video pictures. A typical tile configuration of a picture consists of segmenting the picture into rectangular regions with approximately equal numbers of coding units (CUs) in each tile. A coding unit is analogous to a macroblock (MB) in the H.264 standard. However, the size of the CU can be set by the encoder, and can be larger than a macroblock. The size of the CU can be flexible and adaptive to video content for best partitioning of the picture.

It is noted that each picture may be either a frame or a field. A frame refers to a complete image. A field is a portion of an image used for to facilitate displaying the image on certain types of display devices. Generally, the chroma or luma samples in an image are arranged in rows. To facilitate display an image may sometimes be split by putting alternate rows of pixels into two different fields. The rows of chroma or luma samples in the two fields can then be interlaced to form the complete image. For some display devices, such as cathode ray tube (CRT) displays, the two fields may simply be displayed one after the other in rapid succession. The afterglow of the phosphors or other light emitting elements used to illuminate the pixels in the display combined with the persistence of vision results in the two fields being perceived as a continuous image. For certain display devices, such as liquid crystal displays, it may be necessary to interlace the two fields into a single picture before being displayed. Streaming data representing encoded images typically includes information indicating whether the image is a field or a frame. Such information may be included in a header to the image.

Modern video coder/decoders (codecs), such as MPEG2, MPEG4 and H.264 generally encode video frames as one of three basic types known as Intra-Frames, Predictive Frames and Bipredicitve Frames, which are typically referred to as I-frames, P-frames and B-frames respectively.

An I-frame is a picture coded without reference to any picture except itself. I-frames are used for random access and are used as references for the decoding of other P-frames or B-frames. I-frames may be generated by an encoder to create random access points (to allow a decoder to start decoding properly from scratch at a given picture location). I-frames may be generated when differentiating image details prohibit generation of effective P or B frames. Because an I-frame contains a complete picture, I-frames typically require more bits to encode than P-frames or B-frames. Video frames are often encoded as I-frames when a scene change is detected in the input video.

P-frames require the prior decoding of some other picture(s) in order to be decoded. P-frames typically require fewer bits for encoding than I-frames. A P-frame contains encoded information regarding differences relative to a previous I-frame in decoding order. A P-frame typically references the preceding I-frame in a Group of Pictures (GoP). P-frames may contain both image data and motion vector displacements and combinations of the two. In some standard codecs (such as MPEG-2), P-frames use only one previously-decoded picture as a reference during decoding, and require that picture to also precede the P-frame in display order. In H.264, P-frames can use multiple previously-decoded pictures as references during decoding, and can have any arbitrary display-order relationship relative to the picture(s) used for its prediction.

B-frames require the prior decoding of either an I-frame or a P-frame in order to be decoded. Like P-frames, B-frames may contain both image data and motion vector displacements and/or combinations of the two. B-frames may include some prediction modes that form a prediction of a motion region (e.g., a segment of a frame such as a macroblock or a smaller area) by averaging the predictions obtained using two different previously-decoded reference regions. In some codecs (such as MPEG-2), B-frames are never used as references for the prediction of other pictures. As a result, a lower quality encoding (resulting in the use of fewer bits than would otherwise be used) can be used for such B pictures because the loss of detail will not harm the prediction quality for subsequent pictures. In other codecs, such as H.264, B-frames may or may not be used as references for the decoding of other pictures (at the discretion of the encoder). Some codecs (such as MPEG-2), use exactly two previously-decoded pictures as references during decoding, and require one of those pictures to precede the B-frame picture in display order and the other one to follow it. In other codecs, such as H.264, a B-frame can use one, two, or more than two previously-decoded pictures as references during decoding, and can have any arbitrary display-order relationship relative to the picture(s) used for its prediction. B-frames typically require fewer bits for encoding than either I-frames or P-frames.

As used herein, the terms I-frame, B-frame and P-frame may be applied to any streaming data units that have similar properties to I-frames, B-frames and P-frames, e.g., as described above with respect to the context of streaming video.

For encoding digital video pictures, an encoder receives a plurality of digital images and encodes each image. Encoding of the digital picture may proceed on a section-by-section basis. The encoding process for each section may optionally involve padding, image compression and motion compensation. As used herein, image compression refers to the application of data compression to digital images. The objective of the image compression is to reduce redundancy of the image data for a give image in order to be able to store or transmit the data for that image in an efficient form of compressed data.

Entropy encoding is a coding scheme that assigns codes to signals so as to match code lengths with the probabilities of the signals. Typically, entropy encoders are used to compress data by replacing symbols represented by equal-length codes with symbols represented by codes proportional to the negative logarithm of the probability.

CABAC is a form of entropy encoding used in the H.264/MPEG-4 AVC and High Efficiency Video Coding (HEVC) standards. CABAC is notable for providing much better compression than most other entropy encoding algorithms used in video encoding, and it is one of the key elements that provide the H.264/AVC encoding scheme with better compression capability than its predecessors. However, it is noted that CABAC uses arithmetic coding which may requires a larger amount of processing to decode.

Context-adaptive variable-length coding (CAVLC) is a form of entropy coding used in H.264/MPEG-4 AVC video encoding. In H.264/MPEG-4 AVC, it is used to encode residual, zig-zag order, blocks of transform coefficients. It is an alternative to CABAC. CAVLC uses a table look-up method and thus requires considerably less processing for decoding than CABAC, although it does not compress the data quite as effectively. Since CABAC tends to offer better compression efficiency (about 10% more compression than CAVLC), CABAC is favored by many video encoders in generating encoded bitstreams.

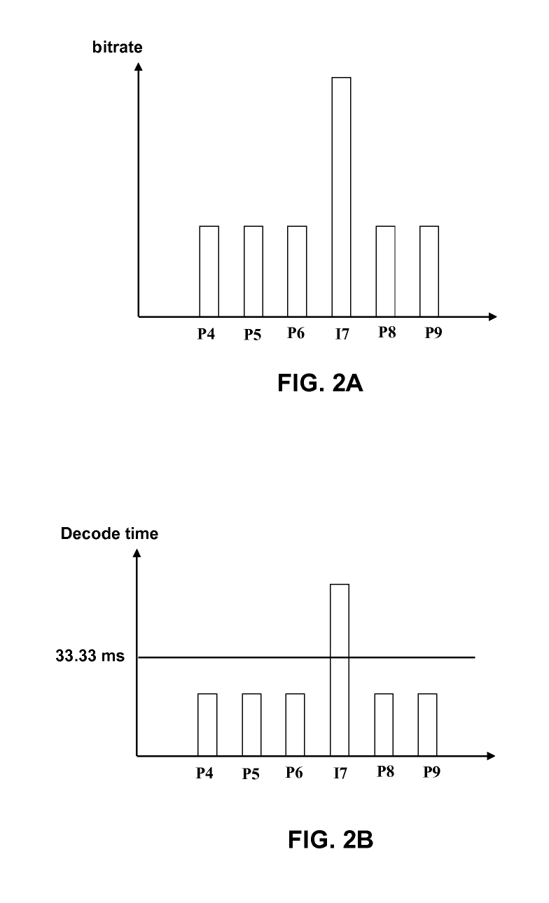

FIGS. 2A and 2B are graphs illustrating a general relationship between the bitrate/decoding time and CABAC encoded frames. In the present context, CABAC uses more bits to encode I-frames compared to P-frames, and thus may require a lot of more time to decode I-frames compared to P-frames, particularly, when the decoding is implemented with a software decoder. In fact, a frame has only 33.33 milliseconds (ms) to decode for a frame rate of 30 frames per second (fps). For a frame rate of 60 fps, 16.67 ms is the upper bound for real-time decoding. As shown in FIG. 2B, an I-frame needs more time to decode than the amount of time has available for typical frame rates. To address this situation, I-frame decoding may use the unused time from P-frame or B-frame decoding. However, when there are many I-frames to decode, this could cause delay or errors in output data stream. Thus, it is desirable to reduce irregular decoding time (e.g., decoding time for I-frames).

### Implementation Examples

Aspects of the present disclosure describe a combined encode/decode strategy to mitigate irregular decoding time in game streaming use case. In this use case, a decoder (a software-based decoder, or a hardware decoder e.g., field-programmable gate array (FPGA)) may be used to decode an incoming video frame. However, due to the characteristics of CABAC entropy decoders, the overall decoder performance may be limited by the performance of CABAC decoding computations, which can result in high delay, especially for software decoders. The situation is even worse for decoding I-frames and IDR frames due to their extremely high bitrate.

Aspects of the present disclosure overcome problems with irregular decoding times that arise when decoding encoded I-frames or IDR-frames or even large P-frames or large B-frames. Aspects of the present disclosure may be implemented with slightly modified encoders and existing optimized decoders. Examples of existing coding standards that may be used include MPEG-1, MPEG-2, MPEG-4 part 2, MPEG-4 part 10 and AVC (H.265). A key feature of aspects of the present disclosure is applying the CAVLC to all I-frames and Instantaneous Decoder Refresh (IDR) frames, while applying CABAC to all other frames in the encoder side. As such, the decoding time for the I-frames and IDR-frames can be reduced and frames can be decoded much faster than before.

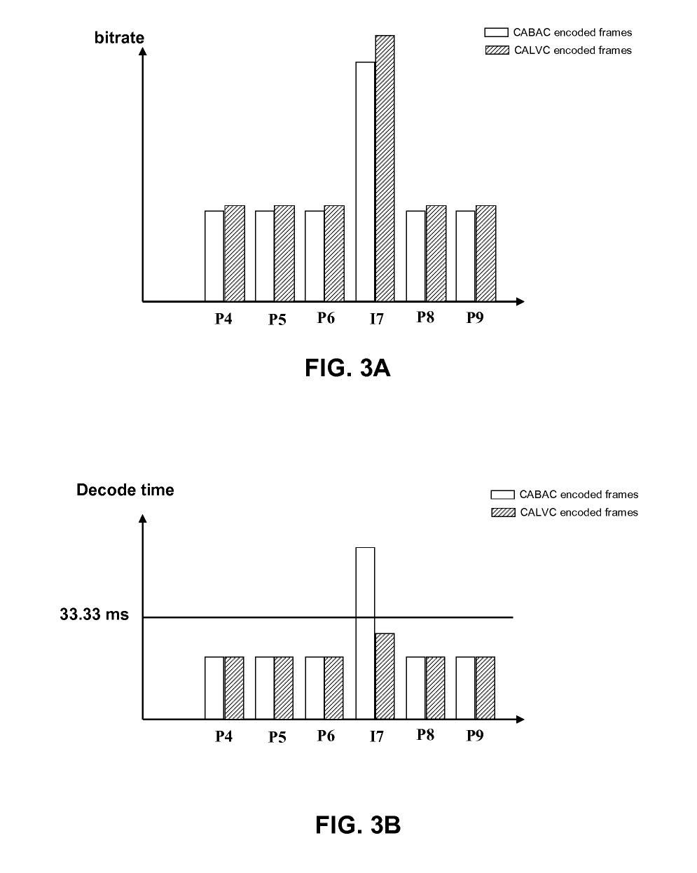

FIGS. 3A and 3B are graphs illustrating a general relationship between bitrate/decode time and CABAC and CAVLC encoded frames in a streaming data picture within the context of aspects of the present disclosure. As shown in FIG. 3A, CAVLC does not compress the I-frame I7 effectively as CABAC (e.g., about 7% less coding efficiency). However, FIG. 3B shows that the CAVLC encoded I-frame is decoded faster than decoding the CABAC encoded I-frame. It is noted that CAVLC uses a table look-up method which is much faster than CABAC that uses arithmetic coding. Thus, in order to make the decoding time more uniform, CAVLC encoding is applied for I-frames or IDR frames while CABAC encoding is applied for other frames (e.g., P-frames or B-frames). Thus, a little coding efficiency for encoding I-frames may be lost but I-frames can decoded faster. In the sequence tested and from MPEG standardization, the data streams have about 5-10% I-frames. In addition, there is typically about I-frame in every 60 frames of a video stream. Thus, the compression efficiency lost in CAVLC encoding I-frames becomes insignificant comparing to the decoding time reduction at the decoding side. In fact, a CAVLC-encoded I-frame typically takes about 20% more time to decode than CABAC encoded P-frame. If both the I-frame and P-frame are CABAC encoded decoding a CABAC-encoded I-frame takes about ten times longer than decoding a CABAC-encoded P-frame.

Although, the foregoing example describes the advantages of encoding I-frames or IDR-frames using a table look-up method (e.g., CAVLC), these advantages may also be realized with P-frames and B-frames, if they are sufficiently large. A number of methods may be used to determine if it would be advantageous to encode a frame using a table look-up method instead of an arithmetic method. Some implementations may compare the size of an encoded frame to a threshold, which may be related to a past frame size (e.g., an average frame size for some number of previous frames) or an expected frame size. By way of example, and not by way of limitation, assume the average encoded P frame size is S for a series of past frames (e.g., P-frames or B-frames or even I-frames or IDR-frames). If the current encoded frame size is greater than TH1*S, where TH1 is a threshold, then the frame may be re-encoded using a table look-up method (e.g., CAVLC). In alternative implementations, the threshold may be related to an expected average frame size, e.g., S=BR/FR, wherein BR is a bitrate at which encoded frames are transmitted and FR is a frame rate at which frames are expected to be presented. In some implementations, the value of TH1 may be inversely related to the percentage of the total decoding time taken up by the arithmetic entropy decoding. By way of example and not by way of limitation, TH1=2 may be chosen if the arithmetic entropy decoding (e.g., CABAC decoding) takes 50% of the total decoding time. In alternative implementations, TH1 may be more generally related to K/F(decoding time %), where K is a constant and F(decoding time %) is some mathematical function of the percentage of the total decoding time taken up by the arithmetic entropy decoding, e.g., a sum, difference, product, power, root, or logarithm. To avoid re-encoding, the encoder may utilize some statistical data (e.g., variance and co-variance of previous encoded frame sizes) before encoding the frame to determine whether to use arithmetic coding (e.g., CABAC) or table-look-up encoding (e.g., CAVLC) to encode the frame.

In other implementations, the encoder may be configured to perform both table look-up encoding and arithmetic coding at the same time, and determine which resulting encoded frame has a better trade-off between encoded frame size and estimated decoding time. By way of example, and not by way of limitation, if the size difference between the table look-up encoded frame and the arithmetic encoded frame is very small (e.g., less than 10%, less than 5% or less than 1%), table look-up encoding may be a better selection for this frame. The relative difference in frame size depends at least partly on the relative coding efficiency of the arithmetic encoding method compared to the table look-up encoding method. By way of example, and not by way of limitation, CABAC is typically 7% more efficient at coding than CAVLC, in which case, CAVALC may be used instead of CABAC if the size difference is smaller than 7%, implying that the CABAC coding efficiency is less than expected.

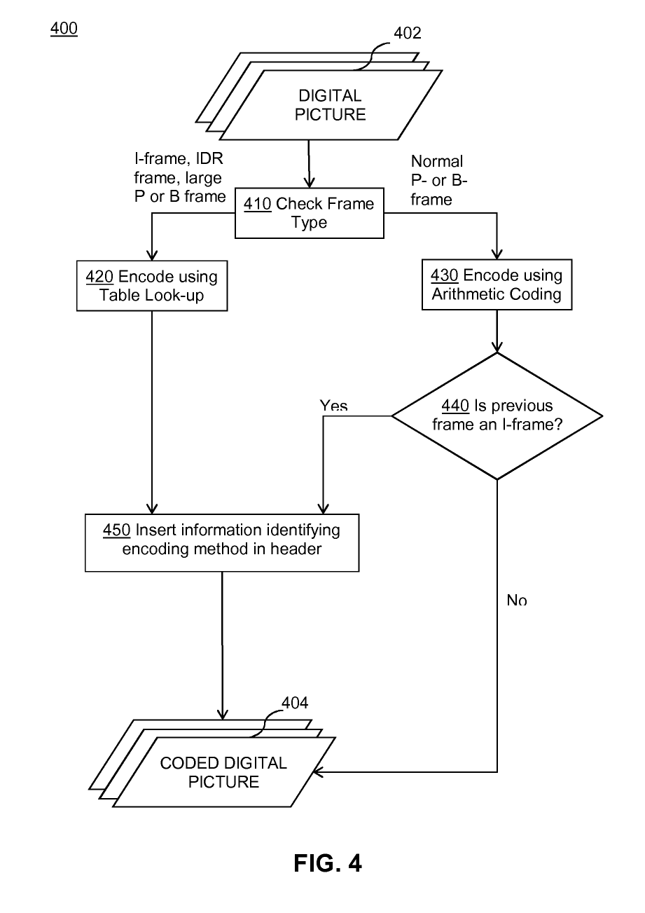

FIG. 4 is a flow diagram illustrating an example of digital picture encoding in accordance with aspects of the present disclosure. Specifically, a digital picture 402 to be encoded is first received at an encoder. At step 410, the encoder is configured to determine whether the picture 402 is an I-frame (or IDR-frame) or P-frame (or B-frames). At step 410 the encoder may also determine whether it would be advantageous to encode the frame using a table look-up method instead of an arithmetic method, e.g., whether the encoded frame would be sufficiently large and/or whether decoding would be sufficiently fast, as discussed above. If it is an I-frame (or IDR-frame) or a sufficiently large P-frame or B-frame, the digital picture 402 is encoded at step 420 using a table look-up method (e.g., CAVLC). After encoding, the encoder is configured to insert information of the encoding method at step 450 in the header of the frame. By way of example and not by way of limitation, the digital picture 402 may have an entropy selection syntax element in its header that instructs a decoder at the decoding side which entropy decoding is required for this current frame.

On the other hand, if it is a normal P-frame (or B-frame), the digital picture 402 may be encoded at step 430 using an arithmetic coding method (e.g., CABAC). In one implementation, the encoder may be configured to insert information identifying the encoding method at step 450 in the header of the frame before encoding the P-frame (or B-frame). For a typical P-frame, the encoder does not need to insert any header info (e.g., the Sequence Parameter Set (SPS) or Picture Parameter Set (PPS) in the AVC H.264 coding standard.). In the case of a current P frame for which the previous frame is an I-frame or and IDR frame, the encoder can insert the SPS or PPS information before encoding. Similarly, for a current P frame for which the previous frame is a table look-up encoded P-frame or B-frame a new SPS or PPS can be inserted before encoding. In another implementation, the encoder is configured to first determine if the frame immediately before this P-frame (or B-frame) is an I-frame at step 440. Then information identifying the encoding method may be inserted in the header of this encoded frame at step 450 only if the frame immediately before this P-frame (or B-frame) is an I-frame. According to the process above, the encoder may output coded picture frame 404.

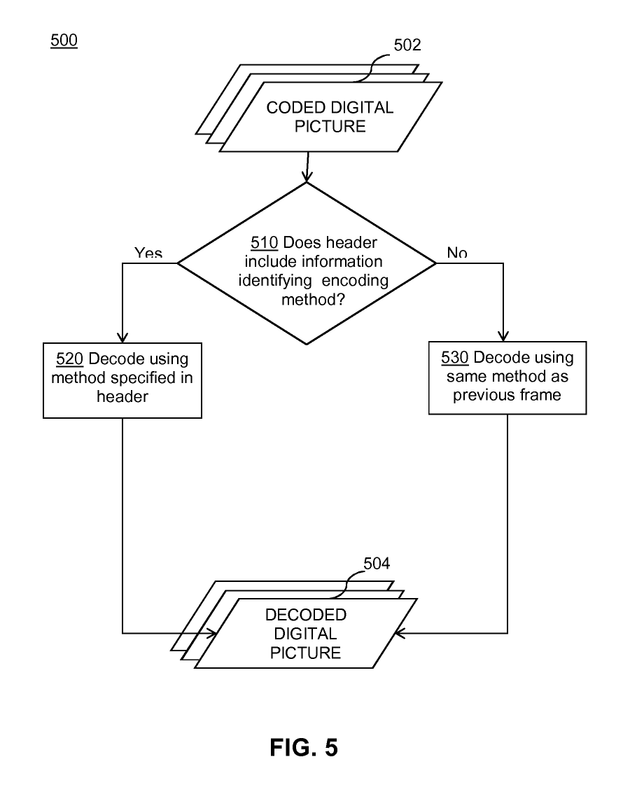

FIG. 5 is a flow diagram illustrating an example of digital picture decoding in accordance with aspects of the present disclosure. An encoded digital picture 502 is received at a decoder. The decoder is configured to check the header of the encoded digital picture 502 for information of the encoding method or decoding instruction (e.g., a syntax element). If the header has information identifying the encoding method, a decoding instruction, the decoder is configured to use decode the encoded digital picture 502 according to the decoding method specified in the header at step 520. The decoder may be configured to use a table look-up method (e.g., CAVLC) to decode the encoded digital picture 502 when the header has a syntax element that instructs the decoder to decode with the table look-up method. The decoder may be configured to use an arithmetic method (e.g., CABAC) to decode the picture 502 when the header has a syntax element that instructs the decoder to decode with that method.

If the header of the encoded digital picture 502 has no information/instruction about the encoding/decode method, the decoder is configured to use the same method to decode the encoded digital picture 502 as was used for the previous frame at step 530. The decoder may be configured to use a table look-up method (e.g., CAVLC) to decode the encoded digital picture 502 when the previous frame immediately before the picture 502 is decoded using that method and to use an arithmetic method (e.g., CABAC) to decode the picture frame 502 when the previous frame immediately before the encoded digital picture 502 is decoded using that method. According to the process above, the decoder may generate the digital picture 504 as output data stream.

In the above embodiments, the information of entropy selection is inserted in the header of the picture frame. In order to avoid losing the header during transmission, each I-frame (or IDR-frame) and the first P-frame (or B-frame) subsequent to an I-frame can be sent by a more reliable channel e.g., Transmission Control Protocol (TCP) or User Datagram Protocol with forward error correction (FEC). In the context of AVC codecs, typically the SPS/PPS header is considered as a non-VCL (Non-Video Coding Layer) data, meaning that this header can be sent separately from the VCL data, e.g., by a more reliable channel. The routing decision may be decided by an upper layer (e.g., a system layer) that is separate from the encoder.

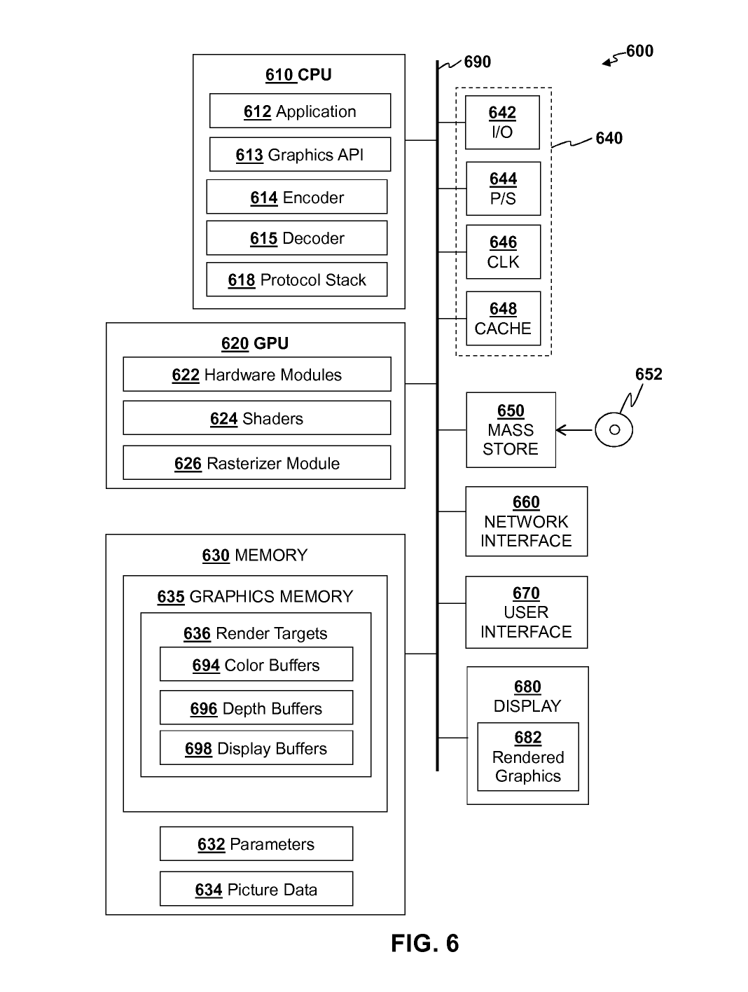

FIG. 6 illustrates an example of a computing system 600 configured to operate in accordance with aspects of the present disclosure. The system 600 may be configured to encode digital pictures in accordance with aspects described above. According to aspects of the present disclosure, the system 600 may be an embedded system, mobile phone, personal computer, tablet computer, portable game device, workstation, game console, and the like.

The system 600 may generally include a processor module and a memory configured to implemented aspects of the present disclosure, e.g., by generating digital pictures, encoding the digital pictures by performing a method having features in common with the method of FIG. 4, and transmitting the encoded pictures over a network. In the illustrated example, the processor module may include a central processing unit (CPU) 610, a graphics processing unit (GPU) 620, and a memory 630. The memory 630 may optionally include a main memory unit that is accessible to both the CPU and GPU, and portions of the main memory may optionally include portions of the graphics memory 635. The CPU 610 and GPU 620 may each include one or more processor cores, e.g., a single core, two cores, four cores, eight cores, or more. By way of example and not by way of limitation, the CPU 610 may be part of an accelerated processing unit (APU) that includes the CPU 610, and the GPU 620 on a single chip. In alternative implementations, the CPU 610 and GPU 620 may be implemented as separate hardware components on separate chips. The CPU 610 and GPU 620 may be configured to access one or more memory units using a data bus 690, and, in some implementations, it may be useful for the system 600 to include two or more different buses.

The memory 630 may include one or more memory units in the form of integrated circuits that provides addressable memory, e.g., RAM, DRAM, and the like. The memory may contain executable instructions configured to implement a method for encoding and/or decoding a picture in accordance with the embodiments described above. The graphics memory 635 may temporarily store graphics resources, graphics buffers, and other graphics data for a graphics rendering pipeline. The graphics buffers may include, e.g., one or more vertex buffers for storing vertex parameter values and one or more index buffers for storing vertex indices. The graphics buffers may also include a one or more render targets 636, which may include both color buffers 694 and depth buffers 696 holding pixel/sample values computed as a result of execution of instructions by the CPU 610 and GPU 620. In certain implementations, the color buffers 694 and/or depth buffers 696 may be used to determine a final array of display pixel color values to be stored in a display buffer 698, which may make up a final rendered image intended for presentation on a display. In certain implementations, the display buffer may include a front buffer and one or more back buffers, and the GPU 620 may be configured to scanout graphics frames from the front buffer of the display buffer 698 for presentation on a display 680.

The CPU 610 may be configured to execute CPU code, which may include an application 612 that utilizes rendered graphics (such as a video game) and a corresponding graphics API 613 for issuing draw commands or draw calls to programs implemented by the GPU 620 based on the state of the application 612. The CPU code may also implement physics simulations and other functions.

The CPU 610 may include an encoder 614 and/or decoder 615 configured to implement video respective encoding and decoding tasks including, but not limited to, encoding and/or decoding a picture in accordance with FIG. 4 and FIG. 5 and embodiments described above. In an alternative implementation, the encoder 614 and decoder 615 may be part of a video coding engine that includes both the encoder and decoder, wherein the video coding engine may be implemented in hardware (e.g., FPGA), in software, or in some combination of hardware and software. The encoder 614 and decoder 615 may be respectively configured to implement video encoding and decoding tasks including, but not limited to, encoding and/or decoding a picture in accordance with the examples described above with respect to FIG. 4 and FIG. 5. In an alternative implementation, the encoder and decoder may be part of a video coding engine that includes both the encoder and decoder, wherein the video coding engine may be implemented in hardware, in software, or in some combination of hardware and software. In hardware implementations the video coding engine hardware may be part of the CPU 610, part of the GPU 620, a separate hardware component of the APU or a separate hardware component from the APU, CPU, and GPU. In some software implementations the encoder 614 and decoder 615 may be partly or wholly implemented by execution of coded instructions with the GPU 620. The CPU code may also include a network protocol stack 618 configured to allow the system 600 to transmit the resulting encoded pictures or encoded sections over the network via the network interface 660.

To support the rendering of graphics, the GPU 620 may execute shaders 624, which may include vertex shaders and pixel shaders. The GPU 620 may also execute other shader programs, such as, e.g., geometry shaders, tessellation shaders, compute shaders, and the like. The GPU may also include specialized hardware modules 622, which may include one or more texture mapping units and/or other hardware modules configured to implement operations at one or more stages of a graphics pipeline, which may be fixed function operations. The shaders 624 and hardware modules 622 may interface with data in the memory 620 and the buffers 636 at various stages in the pipeline before the final pixel values are output to a display. The GPU may include a rasterizer module 626, which may be optionally embodied in a hardware module 622 of the GPU, a shader 624, or a combination thereof. The rasterization module 626 may be configured take multiple samples of primitives for screen space pixels and invoke one or more pixel shaders according to the nature of the samples.

The system 600 may also include well-known support functions 640, which may communicate with other components of the system, e.g., via the bus 690. Such support functions may include, but are not limited to, input/output (I/O) elements 642, power supplies (P/S) 644, one or more clocks (CLK) 646, which may include separate clocks for the CPU and GPU, respectively, and one or more levels of caches 648, which may be external to the CPU 610. The system 600 may optionally include a mass storage device 650 such as a disk drive, CD-ROM drive, flash memory, tape drive, Blu-ray drive, or the like to store programs and/or data. In one example, the mass storage device 650 may receive a computer readable medium 652 containing video data to be encoded and/or decoded. Alternatively, the application 652 (or portions thereof) may be stored in memory 630 or partly in the cache 648.

The system 600 may also include a display unit 680 to present rendered graphics 682 prepared by the GPU 620 to a user. The system 600 may also include a user interface unit 670 to facilitate interaction between the system 600 and a user. The display unit 680 may be in the form of a flat panel display, cathode ray tube (CRT) screen, touch screen, head mounted display (HMD) or other device that can display text, numerals, graphical symbols, or images. The display 680 may display rendered graphics 682 processed in accordance with various techniques described herein. The user interface 670 may one or more peripherals, such as a keyboard, mouse, joystick, light pen, game controller, touch screen, and/or other device that may be used in conjunction with a graphical user interface (GUI). In certain implementations, the state of the application 612 and the underlying content of the graphics may be determined at least in part by user input through the user interface 670, e.g., in video gaming implementations where the application 612 includes a video game or other graphics intensive application.

The system 600 may also include a network interface 660 to enable the device to communicate with other devices over a network. The network may be, e.g., a local area network (LAN), a wide area network such as the internet, a personal area network, such as a Bluetooth network or other type of network. Various ones of the components shown and described may be implemented in hardware, software, or firmware, or some combination of two or more of these.

The memory 630 may store parameters 632 and/or picture data 634 or other data. During execution of programs, such as the application 612, graphics API 613, or encoder/decoder 614/615, portions of program code, parameters 632 and/or data 634 may be loaded into the memory 630 or cache 648 for processing by the CPU 610 and/or GPU 620. By way of example, and not by way of limitation, the picture data 634 may include data corresponding video pictures, or sections thereof, before encoding or decoding or at intermediate stages of encoding or decoding. In the case of encoding, the picture data 634 may include buffered portions of streaming data, e.g., unencoded video pictures or portions thereof. In the case of decoding, the data 634 may include input data in the form of un-decoded sections, sections that have been decoded, but not post-processed and sections that have been decoded and post-processed. Such input data may include data packets containing data representing one or more coded sections of one or more digital pictures. By way of example, and not by way of limitation, such data packets may include a set of transform coefficients and a partial set of prediction parameters. These various sections may be stored in one or more buffers. In particular, decoded and/or post processed sections may be stored in an output buffer, which may be implemented in the memory 630. The parameters 632 may include adjustable parameters and/or fixed parameters.

Programs implemented by the CPU and/or GPU (e.g., CPU code, GPU code, application 612, graphics API 613, encoder/decoder 614/615, protocol stack 618, and shaders 624) may be stored as executable or compilable instructions in a non-transitory computer readable medium, e.g., a volatile memory, (e.g., RAM) such as the memory 630, the graphics memory 635, or a non-volatile storage device (e.g., ROM, CD-ROM, disk drive, flash memory).

Aspects of the present disclosure describe a method encoding the digital picture with an entropy coding method in accordance with the frame type of the picture frame so as to mitigate irregular decoding time due to different frame type. Specifically, aspects of the present disclosure provide reduction on decoding time of encoded I-frames in a way that can be implemented in a fairly straightforward manner with modified versions of existing codec software or hardware. In some implementations, no modification is required on the decoder side. In other implementation, the modifications are straightforward.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A digital picture encoding method, comprising:
determining a frame type of a digital picture; and
encoding the digital picture using an entropy coding method in accordance with the frame type of the digital picture.

2. The method of claim 1, wherein determining the frame type of the digital picture includes determining whether the digital picture is an I-frame, an IDR frame, a P-frame, or a B-frame.

3. The method of claim 1, wherein determining the frame type of the digital picture includes determining whether it would be advantageous to encode the digital picture using a table look-up method instead of an arithmetic method.

4. The method of claim 1, wherein encoding the digital picture using an entropy coding method in accordance with the frame type of the digital picture includes encoding the digital picture with a table look-up method when the digital picture is an I-frame or an IDR-frame, and encoding the digital picture with an arithmetic method when the digital picture is a P-frame or a B-frame.

5. The method of claim 4, wherein the table look-up method is Context-adaptive variable-length coding (CAVLC).

6. The method of claim 4, wherein the arithmetic method is Context Adaptive Binary Arithmetic Coding (CABAC).

7. The method of claim 1, wherein determining the frame type of the digital picture includes determining whether it would be advantageous to encode the digital picture using a table look-up method instead of an arithmetic method and wherein encoding the digital picture using an entropy coding method in accordance with the frame type of the digital picture includes encoding the digital picture using the table look-up method when it is determined it would be advantageous to encode the digital picture using the table look-up method instead of the arithmetic method.

8. The method of claim 7, wherein determining whether it would be advantageous to encode the digital picture using a table look-up method instead of an arithmetic method includes B-frame.

9. The method of claim 7, wherein determining whether it would be advantageous to encode the digital picture using a table look-up method instead of an arithmetic method includes determining a tradeoff between a size and a decoding time for the digital picture when encoded by the table look-up method compared to the arithmetic method.

10. The method of claim 1, further comprising inserting information identifying the entropy coding method in a header of the digital picture.

11. The method of claim 1, further comprising inserting information identifying the entropy coding method in a header of the digital picture when the digital picture is an I-frame or IDR-frame, or a P-frame or B-frame immediately subsequent to an I-frame or IDR-frame.

12. A system, comprising:
a processor;
a memory; and
processor executable instructions embodied in the memory, the instructions being configured to implement a digital picture encoding method upon execution by the processor, the method comprising:
determining a frame type of the digital picture; and
encoding the digital picture with an entropy coding method in accordance with the frame type of the digital picture.

13. The system of claim 12, wherein determining the frame type of the digital picture includes determining whether the digital picture is an I-frame, an IDR frame, a P-frame, or a B-frame.

14. The system of claim 12, wherein determining the frame type of the digital picture includes determining whether it would be advantageous to encode the digital picture using a table look-up method instead of an arithmetic method.

15. The system of claim 12, wherein encoding the digital picture includes encoding the digital picture with a table look-up method when the digital picture is an I-frame or an IDR-frame frame, and encoding the digital picture with an arithmetic method when the digital picture is a P-frame or a B-frame.

16. The method of claim 12, wherein determining the frame type of the digital picture includes determining whether it would be advantageous to encode the digital picture using a table look-up method instead of an arithmetic method and wherein encoding the digital picture using an entropy coding method in accordance with the frame type of the digital picture includes encoding the digital picture using the table look-up method when it is determined it would be advantageous to encode the digital picture using the table look-up method instead of the arithmetic method.

17. The method of claim 16, wherein determining whether it would be advantageous to encode the digital picture using a table look-up method instead of an arithmetic method includes determining a size of the digital picture when encoded when the picture is a P-frame or a B-frame.

18. The method of claim 16, wherein determining whether it would be advantageous to encode the digital picture using a table look-up method instead of an arithmetic method includes determining a tradeoff between a size and a decoding time for the digital picture when encoded by the table look-up method compared to the arithmetic method.

19. The system of claim 12, wherein the method further comprising inserting information identifying the entropy coding method in a header of the digital picture.

20. A non-transitory computer readable medium having computer readable instructions embodied therein, the instructions being configured to implement a digital picture encoding method upon execution by a processor, the method comprising:
determining a frame type of the digital picture; and
encoding the digital picture with an entropy coding method in accordance with the frame type of the digital picture.

21. The non-transitory computer readable medium of claim 20, wherein determining the frame type of the digital picture includes determining whether the digital picture is an I-frame, an IDR frame, a P-frame, or a B-frame.

22. The non-transitory computer readable medium of claim 20, wherein determining the frame type of the digital picture includes determining whether it would be advantageous to encode the digital picture using a table look-up method instead of an arithmetic method.

23. The non-transitory computer readable medium of claim 20, wherein encoding the digital picture includes encoding the digital picture with a table look-up method when the digital picture is an I-frame or an IDR-frame, and encoding the digital picture with an arithmetic method when the digital picture is a P-frame or a B-frame.

24. The non-transitory computer readable medium of claim 20, wherein determining the frame type of the digital picture includes determining whether it would be advantageous to encode the digital picture using a table look-up method instead of an arithmetic method and wherein encoding the digital picture using an entropy coding method in accordance with the frame type of the digital picture includes encoding the digital picture using the table look-up method when it is determined it would be advantageous to encode the digital picture using the table look-up method instead of the arithmetic method.

25. The non-transitory computer readable medium of claim 24, wherein determining whether it would be advantageous to encode the digital picture using a table look-up method instead of an arithmetic method includes determining a size of the digital picture when encoded when the picture is a P-frame or a B-frame.

26. The non-transitory computer readable medium of claim 24, wherein determining whether it would be advantageous to encode the digital picture using a table look-up method instead of an arithmetic method includes determining a tradeoff between a size and a decoding time for the digital picture when encoded by the table look-up method compared to the arithmetic method.

27. The non-transitory computer readable medium of claim 20, wherein the method further comprising inserting information identifying the entropy coding method in a header of the digital picture.

28. A digital picture decoding method, comprising:
determining whether an encoded digital picture includes decoding method identifying information that specifies an encoding method used to encode the encoded digital picture; and
decoding the digital picture using an entropy coding method in accordance with the identifying information when the encoded digital picture includes the encoding method identifying information.

29. The method of claim 28, wherein determining whether the encoded digital picture includes decoding method identifying information specifying the encoding method used to encode the coded digital picture includes checking a header of the coded digital picture.

30. The method of claim 28, further comprising decoding the encoded digital picture using a decoding method used to decode a previous digital picture immediately before the encoded digital picture when the header does not include decoding method identifying information.

31. A system, comprising:
a processor;
a memory; and
processor executable instructions embodied in the memory, the instructions being configured to implement a digital picture decoding method upon execution by the processor, the method comprising:
determining whether an encoded digital picture includes decoding method identifying information that specifies an encoding method used to encode the encoded digital picture; and
decoding the digital picture using an entropy coding method in accordance with the identifying information when the encoded digital picture includes the encoding method identifying information.

32. The system of claim 31, wherein the digital picture decoding method includes determining whether the encoded digital picture includes decoding method identifying information specifying the encoding method used to encode the coded digital picture includes by checking a header of the coded digital picture.

33. The system of claim 31, wherein the method further comprises: decoding the encoded digital picture using a decoding method used to decode a previous digital picture immediately before the encoded digital picture when the header does not include decoding method identifying information.

34. A non-transitory computer readable medium having computer readable instructions embodied therein, the instructions being configured to implement a digital picture decoding method upon execution by a processor, the method comprising:
determining whether an encoded digital picture includes decoding method identifying information that specifies an encoding method used to encode the encoded digital picture; and
decoding the digital picture using an entropy coding method in accordance with the identifying information when the encoded digital picture includes the encoding method identifying information.

35. The non-transitory computer readable medium of claim 34, wherein the digital picture decoding method includes determining whether the encoded digital picture includes decoding method identifying information specifying the encoding method used to encode the coded digital picture includes by checking a header of the coded digital picture.

36. The non-transitory computer readable medium of claim 34, wherein the method further comprises: decoding the encoded digital picture using a decoding method used to decode a previous digital picture immediately before the encoded digital picture when the header does not include decoding method identifying information.
